(19) United States
(12) Patent Application Publication
(10) Pub. No.: US 2020/0226837 A1
(43) Pub. Date: Jul. 16, 2020

(54) LABEL LOCATION SYSTEM WITH VIRTUAL REALITY TECHNOLOGY

(71) Applicant: SPEED 3D Inc., Taipei City (TW)

(72) Inventors: Li-Chuan Chiu, Taipei City (TW); Jui-Chun Chung, Taipei City (TW); Hui-Chun Chen, Taipei City (TW); Yi-Ping Cheng, Taipei City (TW)

(21) Appl. No.: 16/690,132

(22) Filed: Nov. 21, 2019

(30) Foreign Application Priority Data
Jan. 14, 2019 (CN) 201910031322.5

(51) Int. Cl. G06T 19/00; G06T 7/70

(52) U.S. Cl. CPC G06T 19/006; G06T 7/70

(57) ABSTRACT

A label location system with virtual reality technology is provided. The system includes an augmented reality module, a location-based service module, a message storage module, and a message reading module. The augmented reality module is for scanning a specific object to generate a virtual scenario corresponding to the specific object. The location-based service module is coupled to the AR module for confirming a location of the specific object. The message storage module is coupled to the augmented reality module for storing a message generated by an electronic device. The message is generated in correspondence to the generation of the virtual scenario, and a message label corresponding to the message is generated at the location of the specific object. The message reading module adapted to be coupled to the message storage module to trigger the message label so as to read the message.

### BACKGROUND OF THE INVENTION

### 1. Field of the Invention

The present invention relates to a label location system, in particular to a label location system with virtual reality technology.

### 2. Description of the Prior Art

Along with the rapid developments in globalized information technologies, people will have an era of information based on internets and knowledge-based economy. Also, with the developments of internets and smart techs, people are used to have their lives in an internet-based and smart tech-based manner, and to have entertainments combined with internet-based technologies.

Currently, production broadcasts are mainly made through advertisements or brochures in media platforms or product websites of the product, and the consumer has to login in the platform or to access the website to obtain the product information. As a result, when the consumer visits a store selling the product, the consumer cannot have the promotion activities of the store and even the products, unless the consumer asks the staff in the store.

Decades ago, people use letters as a way for long-distance communication; while nowadays people use internets as a medium for message delivery such that people can have the message from others instantly. Nevertheless, there are no efficient solutions when someone wants to keep the message in secret or when someone wants to receive the message only in certain days or certain fields.

In view of these, it is an issue of the present invention to solve these problems by combining nowadays internet technologies and virtual reality technologies.

The features and advantages described in this summary and the following detailed description are not all-inclusive. Many additional features and advantages will be apparent to one of ordinary skill in the art in view of the drawings, specification, and claims hereof.

### SUMMARY OF THE INVENTION

An object of one or some embodiments of the present invention is to combine a location-based service (LBS) module with an augmented reality (AR) module. Therefore, a user can leave a message with any format at a specific location or building in a certain day or during a store event, so that a consumer or another user can trigger the message label to obtain the message upon arrival at the specific location, thereby increasing feeling sharing between friend or people and generating a different way for business promotion.

In view of these, an embodiment of the present invention provides a label location system with virtual reality technology. The label location system is adapted to be written into an application (APP) executed by an electronic device. The label location system comprises an augmented reality (AR) module for scanning a specific object to generate a virtual scenario corresponding to the specific object; a location-based service (LBS) module coupled to the AR module for confirming a location of the specific object; a message storage module coupled to the AR module for storing a message generated by the electronic device, wherein the message is generated in correspondence to the generation of the virtual scenario, and a message label corresponding to the message is generated at the location of the specific object; and a message reading module adapted to be coupled to the message storage module to trigger the message label so as to read the message.

In one or some embodiments, the system further comprises comprising a personnel setting module coupled to the message storage module, wherein the personnel setting module is adapted to edit personnel for triggering the message label.

In one or some embodiments, the system further comprises at least one filtering module coupled to the AR module, wherein the at least one filtering module provides a filter effect in the virtual scenario for the electronic device.

In one or some embodiments, the system further comprises a shopping module coupled to the AR module, wherein the shopping module is adapted to obtain commodity information of an outer label unit and to import the commodity information into the virtual scenario to generate a reality commodity image.

In one or some embodiments, the shopping module comprises a purchase guidance module, wherein the purchase guidance module is adapted to order a commodity corresponding to the reality commodity image through a social networking site.

In one or some embodiments, the social networking site is Facebook, Twitter, or Instagram.

In one or some embodiments, the AR module is adapted to be applied to AR glasses, an AR helmet, a smartphone with an AR function, a computer with an AR function, or a robot with an AR function.

In one or some embodiments, the specific object is a store-specific target of a regional specific target.

In one or some embodiments, the message label is adapted to have a read indication or an unread indication.

### BRIEF DESCRIPTION OF THE DRAWINGS

FIG. 1 illustrates a block diagram of a label location system with virtual reality technology according to one embodiment of the present invention;

FIG. 2 illustrates a schematic flowchart showing the operation of a label location system with virtual reality technology according to one embodiment of the present invention;

FIG. 3 illustrates an operational schematic view showing that a specific object is scanned to locate the object, according to the label location system of one embodiment of the present invention;

FIG. 4 illustrates an operational schematic view showing that a message and a message label corresponding to the message are generated, according to the label location system of one embodiment of the present invention;

FIG. 5 illustrates an operational schematic view showing that the message label is triggered and the message is obtained, according to the label location system of one embodiment of the present invention; and

FIG. 6 illustrates a block diagram showing the operation of buying a product, according to the label location system of one embodiment of the present invention.

### DETAILED DESCRIPTION

These and other features, aspects and advantages of the present invention will become better understood with regard to the following description, appended claims, and accompanying drawings.

The structure, the proportion, and the size shown in the accompanying drawings in the specification are only used for illustration in cooperation with the contents disclosed in the specification, but not used for limiting the scope of the invention. The structure, the proportion, and the size which are adjusted according to requirements have the same effect are also in the scope of the invention. Moreover, the terms, such as “one”, “two”, “upper”, and the like in the specification are used for simplicity and clarity, but not used for limiting the scope of the invention. The relative relation can be changed or adjusted without departing from as the scope of the invention.

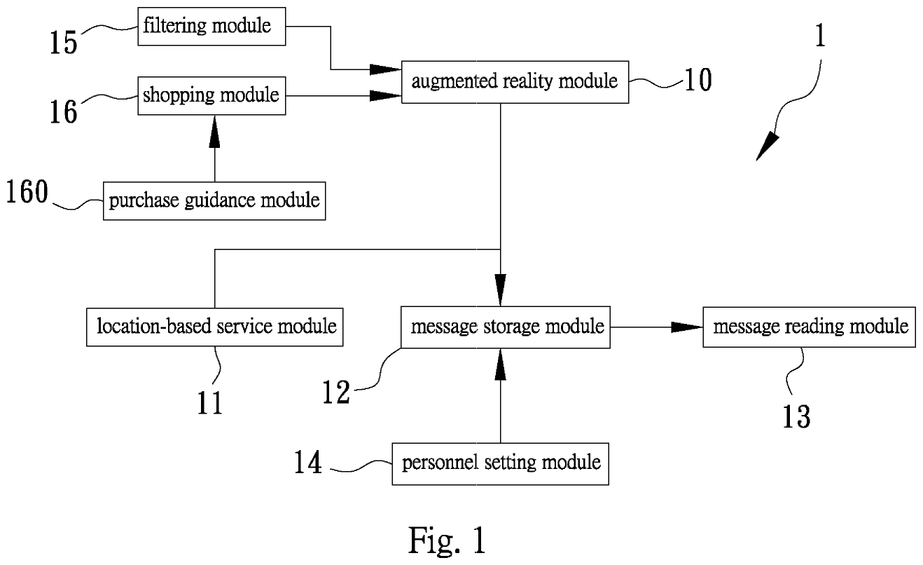

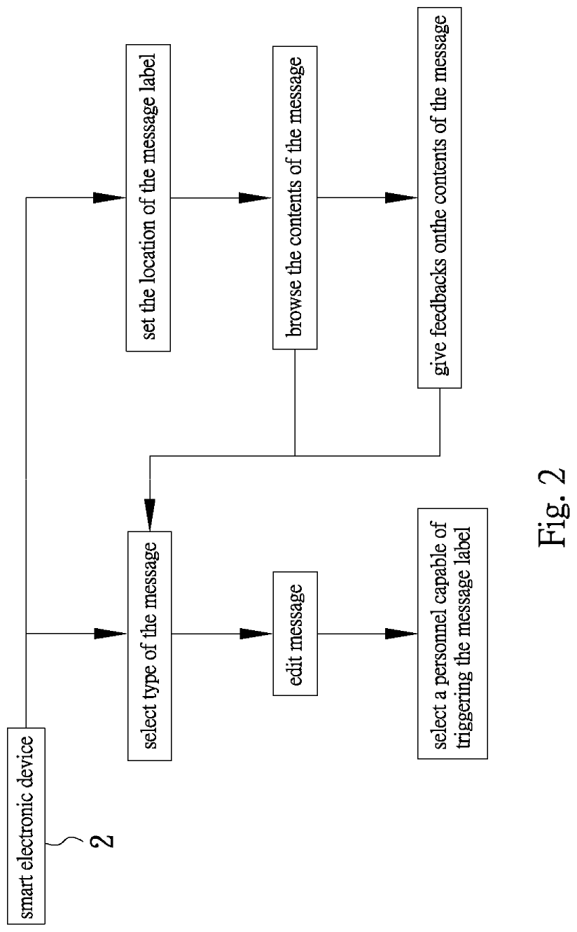

Please refer to FIGS. 1 and 2, respectively illustrating a block diagram of a label location system with virtual reality technology and a schematic flowchart showing the operation of the label location system, according to one embodiment of the present invention. As shown, a label location system (hereinafter, system 1) with virtual reality technology is provided, and the system 1 is adapted to be written into an application (APP) and the APP is executed by an electronic device. The system 1 comprises an augmented reality (AR) module 10, a location-based service (LBS) module 11, a message storage module 12, and a message reading module 13.

Augmented reality (AR) can be implemented by a smart phone or by a smart wearable device. By detailed computation of the position and angles of a camera along with graphical analysis techniques, AR can be used to combine real objects and virtual objects for observing the real environment, so that a user can have interactions with objects in the AR environment. Along with the enhancement of the computation ability of portable electronic devices, the applications of AR become wider.

LBS, an abbreviation for location-based service, uses the network (e.g., GSM network) of a mobile network service provider to obtain the location information (coordinate in latitude and longitude) of a mobile user, is a value-added service for providing users with corresponding services with the supports of electronic map platforms. For example, the dynamic location inquiry service is provided by the M-Zone of China Mobile Communications Corporation.

The AR module 10 is adapted to scan a specific object (which may be a store-specific target or a regional specific target) to generate a virtual scenario corresponding to the specific object. Then, the LBS module 11 is coupled to the AR module 10 to confirm the location of the specific object.

The message storage module 12 is adapted to couple to the AR module 10 for storing a message (which may be virtual data, a text, an acoustic track, an image, or an animation) generated by the electronic device. The message is generated in correspondence to the generation of the virtual scenario, and a message label corresponding to the message is generated at the location of the specific object (the message label may have a read indication or an unread indication).

The message reading module 13 is adapted to couple to the message storage module 12 to trigger the message label so as to read the message.

The AR module 10 may be applied to AR glasses, an AR helmet, a smartphone with an AR function, a computer with an AR function, or a robot with an AR function.

Furthermore, the system 1 may further comprise a personnel setting module 14, at least one filtering module 15, and a shopping module 16. The personnel setting module 14 is coupled to the message storage module 12 and is adapted to edit personnel for triggering the message label.

The filtering module 15 is adapted to couple to the AR module 10 and provides a filtering effect in the virtual scenario for the electronic device 2. The shopping module 16 is coupled to the AR module 10 and is adapted to obtain commodity information of an outer label unit (which may be a barcode or a QR code) and to import the commodity information into the virtual scenario to generate a reality commodity image. Moreover, the shopping module 16 further comprises a purchase guidance module 160. The purchase guidance module 160 is adapted to order a commodity corresponding to the reality commodity image through a social networking site (which may be Facebook, Twitter, or Instagram).

As shown in FIG. 2, it is understood that firstly a user can use an electronic device installed with an application having the label location system 1 to select the type of the message (the message may be virtual data, a text, an acoustic track, an image, or an animation) in the message storage module 12, and edit the selected type of the message to input contents in the message and stored the edited message. Next, the user can select personnel capable of triggering the message label to obtain the message from a personnel list in the personnel setting module 14. Last, the user can confirm the location of a specific object (in this embodiment, a store) with the LBS module 11 and the message label corresponding to the message can be labeled at the selected specific object (in this embodiment, a store). Hence, the selected personnel in the personnel list can trigger the message label to obtain the message.

Moreover, after the type of the message (which may be virtual data, a text, an acoustic track, an image, or an animation) is selected, then the user can label the message label at a specific object nearby, browse contents of the message in the message label, and give feedbacks on the contents of the message to the message storage module 12.

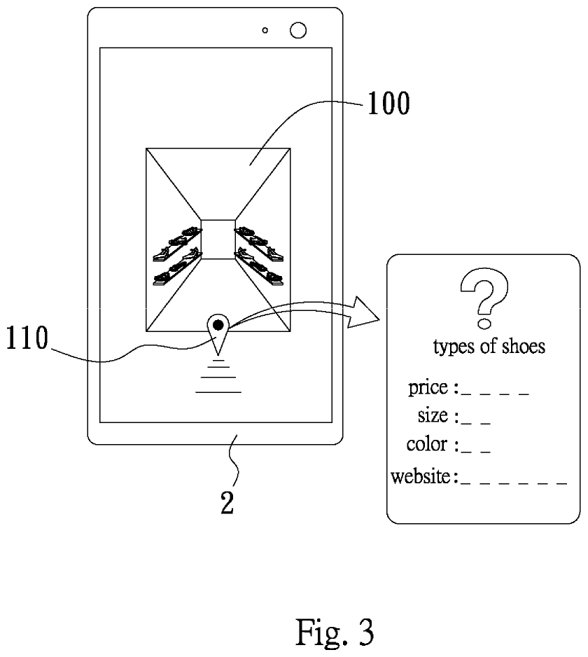

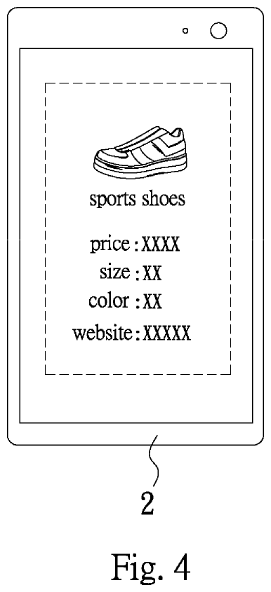

Please refer to FIGS. 3 to 5, respectively illustrating an operational schematic view showing that a specific object is scanned to locate the object, an operational schematic view showing that a message and a message label corresponding to the message are generated, and an operational schematic view showing that the message label is triggered and the message is obtained, according to label location system of one embodiment of the present invention.

As shown in FIGS. 1 and 3, a user executes the label location system 1 in the APP through the electronic device 2, so that the specific object (in this embodiment, a store) is captured by the AR module 10 to generate a virtual scenario 100 corresponding to the specific object, and the LBS module 11 is coupled to the AR module 10 to confirm the location of the specific object. Hence, a message label 110 with an editable message 112 can be generated in front of the store or at a certain location of the store.

Location-based service (LBS) is also called mobile location service, spatial discrimination message service, or in brief location service. LBS is a technology combing mobile GIS technologies, spatial discrimination technologies, and network communication technologies. In LBS, the mobile network service provider provides users with spatial and geographical based message information, and LBS is a practical implementation for mobile GIS technologies.

Communication services become convenient and smart after the infusion of wireless location technologies with the mobile network technologies. The basic principle of the LBS module 11 is briefed as below. When the mobile user needs the message service on a certain mobile terminal or when the surveillance management center needs to perform computation to a certain mobile terminal, the current spatial location data of the mobile terminal can be obtained through the embedded location equipment like GNSS (GPS/GLONASS) in the mobile terminal, and the data are uploaded to the service center in real-time by wireless communication. Next, the GIS server in the service center performs spatial analysis and decision according to the geographical position of the mobile terminal and the service inquiry. Then, the result is downstream to the mobile terminal or the computer in the surveillance management center.

The global navigation satellite system (GNSS) may be, for example, the Global Positioning System (GPS) developed in the United States, the Globalnaya Navigatsionnaya Sputnikovaya Sistema (GLONASS) developed in Russia, and the BeiDou Navigation Satellite System developed in China.

As shown in FIGS. 1, 3, and 4, after the location of the object is located by the LBS module 11, the user can use the message storage module 12 to select the type of the message (which may be virtual data, a text, an acoustic track, an image, or an animation) to generate the message. After the message and the virtual scenario corresponding to the message are built, a message label 110 with contents is generated at the location of the specific object, and the message label 110 may have a read indication or an unread indication. For example, when a consumer arrives at the store, the AR module 10 is triggered to display product recommendation information, evaluation information, or a purchase guidance mode function; the message may have information of product recommendation, store or product evaluation, and information about the purchase guidance mode.

It is understood that, after the message is built, the user may use the personnel setting module 14 to edit the personnel capable of triggering the message label 110. Hence, when the personnel physically visits the certain object, the message label 110 can be triggered.

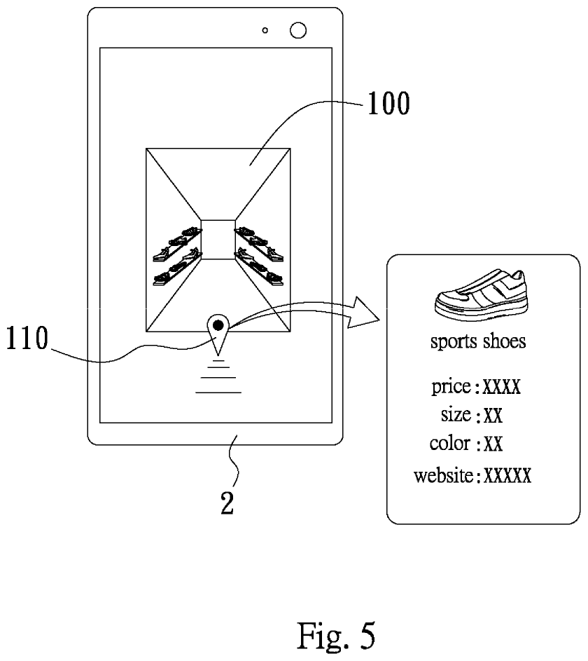

In the embodiment shown FIG. 5, a personnel can use the message reading module 13 of the system 1 to obtain the message. When a personnel visits a specific place (a store, a building, a region, etc.) having the message label 110 corresponding to the personnel, the message reading module 13 of the system 1 can automatically trigger the message label 13 to obtain the message.

A store can put related information about a commodity and activities of the commodity in one message label 110. Hence, anyone can use the message reading module 13 to trigger the message label 110 to obtain the message, so that the contents about the activities of the commodity and information about the commodity can be obtained and understood.

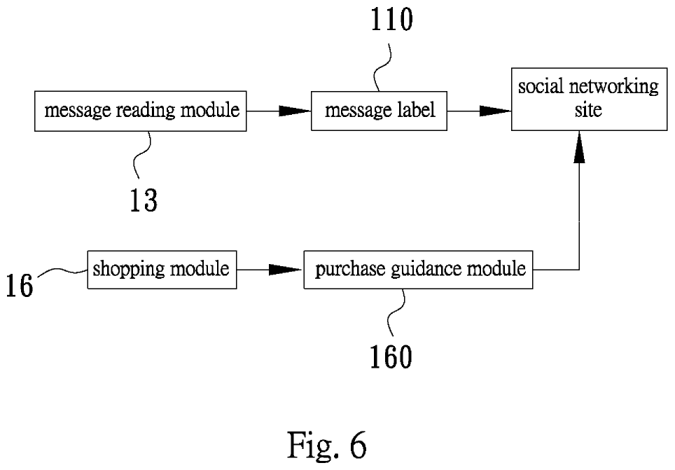

Please refer to FIG. 6, illustrating a block diagram showing the operation of buying a product, according to the label location system of one embodiment of the present invention. In FIG. 6, the purchase guidance module 160 of the shopping module 16 is adapted to order a commodity corresponding to the commodity reality image through a social networking site. Specifically, in this embodiment, the store can provide full information about the commodity (including the specification, the price, the manufacturing place, and websites related to the commodity, etc.) in the message of the message label 110, and the user can obtain the message through the message reading module 13 and enters into the social networking site of the store through links provided in the message. Hence, after the user enters into the web site of the store, the user can use the purchase guidance module 160 of the shopping module 16 to order a commodity or to have more details for the commodity.

As above, according to one or some embodiment of the present invention, the LBS module is combined with the AR module. Therefore, a user can leave a message with any format at a specific location or building in a certain day or during a store event, so that a consumer or another user can trigger the message label to obtain the message upon arrival at the specific location, thereby increasing feeling sharing between friend or people and generating a different way for business promotion. For example, the contents in the message may be letters left for a wife or for a son, and the message can be read when the wife or the son visits a certain building, place, or store.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A label location system with virtual reality technology, wherein the label location system is adapted to be written into an application (APP) executed by an electronic device, the label location system comprises:
an augmented reality (AR) module for scanning a specific object to generate a virtual scenario corresponding to the specific object;
a location-based service (LBS) module coupled to the AR module for confirming a location of the specific object;
a message storage module coupled to the AR module for storing a message generated by the electronic device, wherein the message is generated in correspondence to the generation of the virtual scenario, and a message label corresponding to the message is generated at the location of the specific object; and
a message reading module adapted to be coupled to the message storage module to trigger the message label so as to read the message.

2. The label location system according to claim 1, further comprising a personnel setting module coupled to the message storage module, wherein the personnel setting module is adapted to edit personnel for triggering the message label.

3. The label location system according to claim 1, further comprising at least one filtering module coupled to the AR module, wherein the at least one filtering module provides a filter effect in the virtual scenario for the electronic device.

4. The label location system according to claim 1, further comprising a shopping module coupled to the AR module, wherein the shopping module is adapted to obtain commodity information of an outer label unit and to import the commodity information into the virtual scenario to generate a reality commodity image.

5. The label location system according to claim 4, wherein the shopping module comprises a purchase guidance module, wherein the purchase guidance module is adapted to order a commodity corresponding to the reality commodity image through a social networking site.

6. The label location system according to claim 5, wherein the social networking site is Facebook, Twitter, or Instagram.

7. The label location system according to claim 1, wherein the AR module is adapted to be applied to AR glasses, an AR helmet, a smartphone with an AR function, a computer with an AR function, or a robot with an AR function.

8. The label location system according to claim 1, wherein the specific object is a store-specific target or a regional specific target.

9. The label location system according to claim 1, wherein the message label is adapted to have a read indication or an unread indication.

10. The label location system according to claim 1, wherein the message is virtual data, a text, an acoustic track, an image, or an animation.
